(19) United States
(12) Patent Application Publication
(10) Pub. No.: US 2016/0238121 A1
(43) Pub. Date: Aug. 18, 2016

(54) RACK BELT

(71) Applicant: AISIN SEIKI KABUSHISIKI KAISHA, Kariya-shi (JP)

(72) Inventors: Yusuke KOKUBO, Toyota-shi (JP); Yoichi GOTO, Herrin, IL (US); Mikiyasu FUJII, Wuxi Jiang Su (JP)

(73) Assignee: AISIN SEIKI KABUSHISIKI KAISHA, Kariya-shi (JP)

(21) Appl. No.: 15/040,230

(22) Filed: Feb. 10, 2016

(30) Foreign Application Priority Data
Feb. 12, 2015 (JP) 2015-025474

(51) Int. Cl. F16H 55/26

(52) U.S. Cl. CPC F16H 55/26

(57) ABSTRACT

A rack belt includes: a toothed belt body that is made of resin or rubber and is adapted to move in an extending direction; a first core wire made of metal which is embedded in the belt body in a state of extending in the extending direction of the belt body; and a second core wire made of metal which is embedded in the belt body in a state of being wound around the first core wire.

### CROSS REFERENCE TO RELATED APPLICATIONS

This application is based on and claims priority under 35 U.S.C. §119 to Japanese Patent Application 2015-025474, filed on Feb. 12, 2015, the entire contents of which are incorporated herein by reference.

### TECHNICAL FIELD

This disclosure relates to a rack belt.

### BACKGROUND DISCUSSION

In related art, for example, in a rack belt that is used to drive a sunroof and the like, strength is ensured by embedding a pair of metal core wires which extend in extending directions thereof and are parallel to each other. However, two core wires are disposed at a certain distance within the rack belt thereby impairing bending flexibility of the rack belt.

Therefore, for example, a technique, in which only one core wire is disposed in a center portion on the inside of the rack belt, is disclosed in JP 2007-210362A (Reference 1).

However, in Reference 1, bonding strength between a belt body made of resin forming an outer shape of the rack belt and the core wire is reduced and then mechanical strength of the rack belt can be reduced due to a decrease in the number of the core wires and a decrease in surface area accordingly.

### SUMMARY

Thus, a need exists for a rack belt which is not suspectable to the drawback mentioned above.

A rack belt according to an aspect of this disclosure includes a toothed belt body that is made of resin or rubber and is adapted to move in an extending direction; a first core wire made of metal which is embedded in the belt body in a state of extending in the extending direction of the belt body; and a second core wire made of metal which is embedded in the belt body in a state of being wound around the first core wire.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view illustrating a sunroof apparatus to which an embodiment applied;

FIG. 2 is a perspective view illustrating the embodiment; and

FIG. 3A is a sectional view that is taken along line 3A-3A of FIG. 3B and FIG. 3B is a sectional view that is taken along line 3B-3B of FIG. 3A.

### DETAILED DESCRIPTION

Hereinafter, an embodiment of a rack belt will be described. Moreover, hereinafter, forward and backward directions of a vehicle are referred to as “forward and backward directions”.

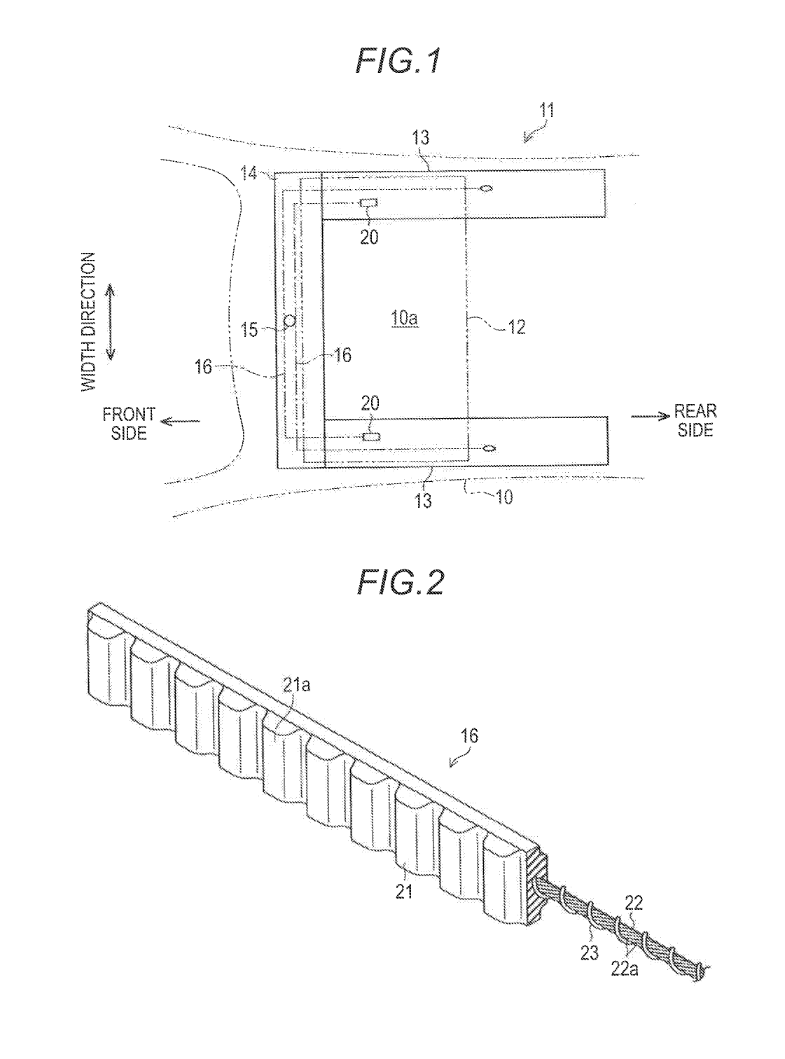

As illustrated in FIG. 1, a sunroof apparatus 11 is mounted on a roof 10 of the vehicle such as an automobile. That is, a substantially rectangular opening 10a is formed in the roof 10 and a substantially rectangular movable panel 12, which is formed of, for example, a glass plate, is disposed in the roof 10. The movable panel 12 opens and closes the opening 10a by moving in the forward and backward directions.

A pair of guide rails 13 are disposed in both edge portions of the opening 10a of the vehicle in a width direction. Each guide rail 13 is made of, for example, an extruded material of aluminum alloy, has a constant cross-section in a longitudinal direction, and extends in the forward and backward directions. Then, a function component 20 is guided and supported on each guide rail 13 to be movable in the forward and backward directions. The movable panel 12 is linked and supported on both function components 20 in a state of being bridged between both the function components 20. Both the function components 20 open and close the movable panel 12 with movement thereof in the forward and backward directions along the guide rails 13.

In addition, front ends of both guide rails 13 are connected together via a front housing 14 extending in the width direction of the vehicle. An electric driving source 15 having an output gear composed of, for example, a spur gear and a motor is disposed in an intermediate portion of the front housing 14 in the longitudinal direction. The electric driving source 15 is connected to each function component 20 via each of a pair of substantially strip-shaped rack belts 16 and moves both the function components 20 simultaneously in the forward and backward directions. Moreover, each rack belt 16 extends in the width direction of the vehicle along the front housing 14, is turned around in the vicinity of a front end of the guide rail 13, and extends on a rear side of the vehicle along the guide rail 13.

Next, a structure of the rack belt 16 described above will be described.

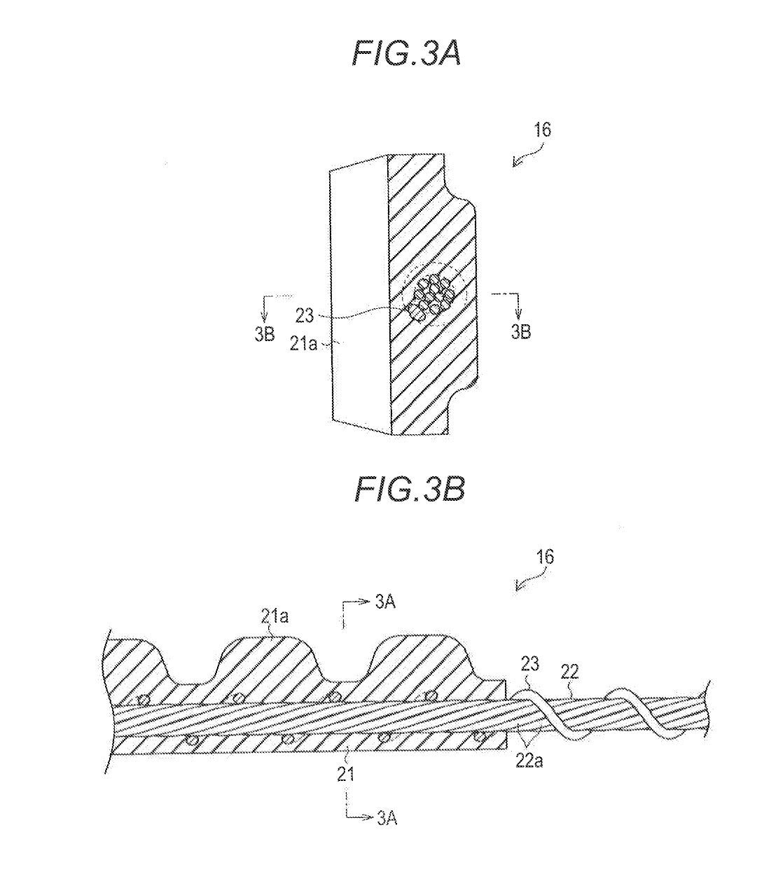

As illustrated in FIGS. 2, 3A, and 3B, the rack belt 16 has a belt body 21 made of resin or rubber (for example, made of elastomer) which forms an outer shape. The belt body 21 has a toothed portion having a rack portion 21a capable of engaging with the output gear described above. Thus, if the output gear rotates, the belt body 21 moves in an extending direction accordingly. Of course, the movement of the function component 20 in the forward and backward directions is achieved by the movement of the belt body 21 extending along the guide rail 13 in the forward and backward directions.

A first core wire 22 made of metal is embedded in the belt body 21 in a state of extending along the extending direction and a second core wire 23 made of metal is embedded in the belt body 21 in a state of being wound helically around the first core wire 22 at a predetermined pitch. The first and second core wires 22 and 23 are disposed in a center portion of the belt body 21 in a tooth width direction.

The first core wire 22 is formed by twisting (so-called twisted wire) a plurality of element wires 22a made of, for example, hard steel wires such as piano wires and the second core wire 23 is made of one hard steel wire. A diameter of the element wire 22a is set to be smaller than a diameter of the second core wire 23. In addition, a twisted pitch of each element wire 22a and a winding pitch of the second core wire 23 are different from each other. That is, the twisted pitch of each element wire 22a and the winding pitch of the second core wire 23 are opposite to each other.

As described above, according to the embodiment, the following advantages can be achieved.

(1) In the embodiment, both the first core wire 22 and the second core wire 23 are embedded in the belt body 21. Thus, it is possible to increase bonding strength with the belt body 21 and to suppress a reduction of mechanical strength of the rack belt 16 by increasing a surface area combining the first core wire 22 and the second core wire 23. On the other hand, the first core wire 22 and the second core wire 23 are collectively disposed in a state where the second core wire 23 is wound around the first core wire 22. Thus, it is possible to ensure bending flexibility of the rack belt 16.

(2) In the embodiment, the pitch of the element wire 22a and the pitch of the second core wire 23 are different from each other. Thus, it is possible to further increase bonding strength with the belt body 21 by an inclination of the element wires 22a and the second core wire 23.

(3) In the embodiment, the pitch of the element wire 22a and the pitch of the second core wire 23 are opposite to each other. Thus, it is possible to increase the inclination of the element wires 22a and the second core wire 23 and to further increase bonding strength with the belt body 21 compared to, for example, a case where the pitch of the element wire 22a and the pitch of the second core wire 23 are in the same direction as each other.

(4) In the embodiment, mechanical strength of the rack belt 16 is appropriately ensured. Thus, it is possible to stabilize and hold a posture of the rack belt 16, for example, even when pressing the function component 20 to open the movable panel 12.

(5) In the embodiment, since the second core wire 23 is only wound around the first core wire 22 having a twisted wire structure, it is unlikely to influence the tensile strength and bending elasticity of the first core wire 22 itself, and it is possible to suppress an increase in sliding resistance, for example, when the rack belt 16 moves.

Moreover, the embodiment described above may be changed as follows.

In the embodiment described above, in the belt body 21, the tooth of the rack portion 21a may be one that is along the tooth width direction or may be one (so-called helical rack) that is inclined with respect to the tooth width direction.

In the embodiment described above, the belt body 21 of the rack belt 16 may be made of, for example, natural rubber.

In the embodiment described above, the first core wire 22 may be configured of one hard steel wire.

This disclosure may be applied to a timing belt for transmitting rotation of a crankshaft of an engine to a cam shaft or a water pump. In addition, if a rack belt is included in a power wind apparatus (regulator) that is driven to open and close a side glass, a power slide door apparatus that is driven to open and close a slide door, a power back door apparatus that is driven to open and close a back door, and the like, this disclosure may be applied to them. Furthermore, this disclosure may also be applied to a rack belt mounted on an arbitrary apparatus other than the vehicle. In short, it may be a rack belt driving an object to be driven in accordance with the movement in the extending direction.

A rack belt according to an aspect of this disclosure includes a toothed belt body that is made of resin or rubber and is adapted to move in an extending direction; a first core wire made of metal which is embedded in the belt body in a state of extending in the extending direction of the belt body; and a second core wire made of metal which is embedded in the belt body in a state of being wound around the first core wire.

According to the configuration, it is possible to increase bonding strength with the belt body and to suppress a decrease in mechanical strength of the rack belt by increasing a surface area combining the first core wire and the second core wire by embedding both the first core wire and the second core wire in the belt body. On the other hand, it is possible to ensure bending flexibility of the rack belt by collectively disposing the first core wire and the second core wire in a state where the second core wire is wound around the first core wire.

With respect to the rack belt, it is preferable that the first core wire is formed by twisting a plurality of element wires, and a pitch of the element wires and a pitch of the second core wire are different from each other.

According to this configuration, the pitch of the element wires and the pitch of the second core wire are different from each other. Thus, it is possible to further increase bonding strength with the belt body by an inclination of the element wires and the second core wire.

With respect to the rack belt, it is preferable that the pitch of the element wires and the pitch of the second core wire are opposite to each other.

According to this configuration, the pitch of the element wires and the pitch of the second core wire are opposite to each other. Thus, it is possible to increase inclination of the element wires and the second core wire and to further increase bonding strength with the belt body compared to, for example, a case where the pitch of the element wires and the pitch of the second core wire are in the same direction as each other.

With respect to the rack belt, it is preferable that the second core wire is embedded in the belt body in a state of being wound helically around the first core wire.

The aspects of this disclosure have an effect of further increasing the mechanical strength.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed:

1. A rack belt comprising:
a toothed belt body that is made of resin or rubber and is adapted to move in an extending direction;
a first core wire made of metal which is embedded in the belt body in a state of extending in the extending direction of the belt body; and
a second core wire made of metal which is embedded in the belt body in a state of being wound around the first core wire.

2. The rack belt according to claim 1,
wherein the first core wire is formed by twisting a plurality of element wires, and
wherein a pitch of the element wires and a pitch of the second core wire are different from each other.

3. The rack belt according to claim 2,
wherein the pitch of the element wires and the pitch of the second core wire are opposite to each other.

4. The rack belt according to claim 1,
wherein the second core wire is embedded in the belt body in a state of being wound helically around the first core wire.
